(19) United States
(12) Patent Application Publication
(10) Pub. No.: US 2014/0038134 A1
(43) Pub. Date: Feb. 6, 2014

(54) Custom dental implants, systems, devices and methods

(71) Applicant: Hao Nguyen, Stockton, CA (US)

(72) Inventor: Hao Nguyen, Stockton, CA (US)

(21) Appl. No.: 13/751,128

(22) Filed: Jan. 27, 2013

Related U.S. Application Data
(60) Provisional application No. 61/591,274, filed on Jan. 27, 2012.

(51) Int. Cl. A61C 8/00

(52) U.S. Cl. CPC A61C 8/0036; A61C 8/005; A61C 8/0089
USPC 433/175

(57) ABSTRACT

The invention concerns an anatomically shaped dental implant section custom shaped to fit the tooth socket of a particular individual and having a ridge circumferentially located that is complementary in size and location to a notch prepared in the tooth socket. The invention further concerns a pilot tool for the removal of soft tissue from the tooth socket prior to implantation, as well as an undercut pilot tool for placing a notch in the proximal walls of the tooth socket. The invention also concerns a dental implant system containing at least two separate dental implant sections that can be joined together to form a dental implant custom shaped to fit the tooth socket of a particular individual. The invention also concerns a method of implanting a dental implant of the present invention by sequentially positioning anatomically shaped implant sections in the root voids of the tooth socket and then joining the coronal ends of the anatomically shaped implant sections to form an anatomically shaped implant. The invention also concerns a dental implant system comprising a custom shaped dental implant, one or more soft tissue pilot tools and one or more undercut pilot tools.

### RELATED APPLICATIONS

This application claims the benefit of U.S. Provisional Application No. 61/591,274, filed Jan. 27, 2012. The present application is related to U.S. Regular Patent Application entitled “Prefabricated Immediate No-Drill Dental Implant,” by Hao Van Nguyen, filed on the same day as this application, the content of which is expressly incorporated by reference herein in its entirety.

### BACKGROUND OF THE INVENTION

1. Field of the Invention

The present invention relates generally to the field of dentistry and particularly to the field of dental restorations, implants and prostheses. More specifically, the present invention is directed toward a dental implant, an implant system including dental devices and an implant method to install a dental implant.

2. Description of Related Art

Dental implants are the subject of much study. A typical dental implant system has three main components: 1) an implant, which is generally a titanium screw, 2) an abutment that attaches to the implant; and 3) a crown to restore the missing tooth. Some dental implant systems do not have the abutment, and the crown is connected directly to the implant. An artificial dental implant is implanted into the jawbone of a patient and, after bone has grown around the implant, an artificial tooth or bridge is affixed thereto by a screw or by cement. Traditionally, the implant is placed in the bone and covered with mucosa, but out of occlusal load, during a three to five month post-operative healing period, after which time a second surgery is performed to fit the desired prosthesis. It is more common now that implants and crowns are placed immediately following extraction. However, without the completion of osseointegration, there remains a risk of failure of the implant upon loading.

Generally, a void is created in the jaw bone by pre-drilling the jaw bone in order to accommodate a screw or projection on an artificial implant. Then an implant having a threaded projection is screwed into the bone of the prepared site so that the threaded projection is anchored in the drilled out area to secure the implant body in the socket and to provide an anchor to attach a replacement tooth. A hallmark of the currently accepted process of placing implants is the step of drilling the jaw bone to fit the shape of a portion of the implant. This method has many drawbacks and is not suitable for all implant situations.

Traditionally, implants have been selected for use from a commercially available supply of implants of generic shape, available in a standard series of sizes, rather than custom shaped anatomically to fit within the root cavity of a particular patient. Creation of a void or osteotomy by drilling in order to affix part of the implant therein is commonly viewed as necessary because the implant, not being a custom fit, would not generally be secure within the gum but for an anchoring within the jaw bone.

While drilling has been treated as an essential step in implant surgery in order to insure stability of the implant and attached tooth, there are several drawbacks to drilling into the jaw bone. These drawbacks include, but are not limited to, bone necrosis due to overheating during drilling process with insufficient irrigation, cortical plate perforation or fracture, poor implant and root proximity and poor implant angulation.

Even where a patient is an ideal candidate for an implant, a dentist must use great care, skill and expertise when drilling into the jaw to avoid damaging vital jaw and face structures. The currently accepted implant methods that use drilling require significant skill when preparing the site for placement of the implant. Systems require the use of several drill bits and often complicated sequences that the clinician must follow to prepare the site. Additionally, the angulation of the drill, the diameter, and the length of the implant must all be taken into careful consideration to assure success in placing the implant.

Any time the jaw bone is drilled, heat will be generated and, with insufficient irrigation, the bone can be burned or otherwise damaged, which can result in bone necrosis and dental implant failure.

The process of drilling in order to place an implant always involves the risk of impinging on or invading other anatomical structures in the oral cavity, including, without limitation, the mental foramen and mental nerve, the inferior alveolar (mandibular) nerve, and the maxillary sinus.

Even where an implant is successfully positioned by drilling and has osseointegrated, attaching the replacement prosthesis may pose additional challenges because of the effect of the positioning of the implant, as well as the angulation, of the final prosthesis that will attach to it. The positioning of the prosthesis is determined by the original implant placement. Sometimes, after osseointegration, it is discovered that an implant must be removed due to its positioning at an improper angle, resulting in the inability to affix a restorative prosthesis appropriately to satisfy dental esthetic requirements.

Positioning a dental implant by drilling can also necessitate additional procedures, such as sinus lifts or other bone grafting, particularly for upper molars and upper anteriors, which have stricter esthetic demands. The upper molar alveolar ridge often does not have sufficient bone height to accommodate drilling for placement of an implant due to the proximity of the floor of the maxillary sinus. Fixing an implant by use of a drill often requires a sinus lift to establish enough bone height to allow for the drilling. This procedure by itself adds the risk of more complications that threaten the success of the dental implant.

When drilling in order to place an implant, there is a risk that the drill bit will perforate the cortical bone if it is not angled properly during the osteotomy preparation phase. It can break the cortical bone plate if an implant is used that has a diameter that is too big for the jaw bone to support. The vibration of the implant drill can also break the cortical bone plate. Further, some patients have characteristics that increase the risks associated with drilling. Where there is insufficient bone or a condition that weakens the bone, drilling into the bone could result in irreparable damage, leaving no firm place to anchor the implant. When implanting in the upper jaw there is a risk of perforating the sinus, which exposes the patient to infection. Drilling also exposes the patient to the risk of nerve damage as well as damage to surrounding teeth and blood vessels. Some patients simply make poor candidates for traditional implant techniques because the structure of the bone underlying the root does not permit drilling for any number of reasons.

A wide variety of dental implants and systems are known. In response to the above shortcomings, some methods have been proposed to attempt to overcome them.

U.S. Pat. No. 6,099,313 (Dorken), hereby incorporated by reference in its entirety, describes a bone contact section that is root shaped and that has an apical extension and an abutment section for fitting a crown. Drilling is described in order to accommodate this extension portion.

U.S. Pat. No. 5,562,450 (Burkhardt), referencing German application DE 27 29 969 A1, both of which are hereby incorporated by reference in their entirety, discloses a dental implant which is substantially modeled on or is a copy of the removed tooth made by copy milling. The '450 patent describes the problem of the gap between the dental implant described in the German application and the tooth socket that arose from the removal of connective tissue prior to placement of the implant. The '450 patent teaches a solution by enlarging the implant to be slightly bigger than the tooth socket to provide compression pressure for stability of the implant.

U.S. patent application Ser. Nos. 11/724,261 and 11/549,782 (Rubbed), both of which are hereby incorporated by reference in their entireties, describe a customized dental prosthesis for osseointegration having a first manufactured portion shaped to substantially conform to the three-dimensional surface of a root of a tooth to be replaced and a second manufactured portion shaped to substantially conform to the three-dimensional surface of a crown of a tooth to be replaced. These applications have detailed descriptions of the background of customized implants and guidance on how to make a customized implant from which one can determine how to make an implant that substantially conforms to the three dimensional surface of a root of a tooth to be replaced. For example, they describe a CAD/CAM based method of and a system for manufacturing a customized dental prosthesis replacing an extracted tooth, where the extracted tooth is scanned regarding its three-dimensional shape and substantially copied using (a) an imaging system in-vitro such as a 3D scanner or in-vivo such as a cone beam CT system, (b) CNC machinery and (c) biocompatible material that is suitable to be integrated into the extraction socket and at least partially adopted by the existing tissue forming the socket. The two applications set forth a background and guide to prosthesis implantation.

For teeth with more than one root, the roots are sometimes situated in a manner that prevents the tooth from being extracted intact due to the angle the roots form in relation to each other. In order to extract such teeth, the two or three roots must have a separate path of extraction, necessitating the division of the tooth into more than one piece prior to extraction to free each root to be extracted.

Similarly, in order to place a custom shaped implant body into the void left by such a multi-rooted tooth, it is not possible to insert an implant body having custom root shaped projections into such a void intact.

Each of these implant options and methods are deficient, either requiring drilling or admitting of improvements in stability. Further, they do not disclose implants comprised of two or more root sections for multiple rooted teeth.

Despite the efforts of many practitioners in the field, a need remains for immediately stable implants and systems for both single rooted and multi-rooted teeth that do not require drilling into the bone. A general object of the present invention is to obviate drawbacks associated with the prior art; to provide methods and devices for securely placing an anatomically shaped implant without drilling the jaw bone, and to provide methods and devices for implanting an anatomically shaped implant in sections in a multi-rooted tooth socket where the voids left by the roots are situated in relation to each other in a way that prevents the insertion of a single anatomically shaped implant.

The difficulties and limitations suggested in the preceding are not intended to be exhaustive, but rather are exemplary of the many devices which demonstrate that, despite much attention in the art to improving dental implant methods and devices, the devices and methods in the art will admit to useful improvements.

### SUMMARY OF THE INVENTION

It is therefore an object of the present invention to provide a dental implant that provides improved stability without requiring drilling into the jawbone. In particular, it is an object of the present invention provide a dental implant that is custom shaped to fit the geometry of the socket into which it is to be placed, and has additional stabilizing features.

It is a further object of the present invention to provide a tool to safely remove periodontal tissue from a tooth socket prior to insertion of the above anatomically shaped implant.

It is yet a further object of the present invention to provide a tool to create one or more notches in the wall of the tooth socket to accommodate one or more ridges on an anatomically shaped implant.

It is another object of the present invention to provide at least two anatomically shaped implant sections that can be joined together at their coronal end to form an anatomically shaped implant, allowing sequential placement of implant sections into each of the root voids in multiple rooted tooth sockets.

It is another object of the present invention to provide a method of placing an anatomically shaped implant in a multi-rooted tooth socket comprising sequentially positioning anatomically shaped implant sections in the root voids of the tooth socket and then joining the coronal ends of the anatomically shaped implant sections to form an anatomically shaped implant.

In one aspect of the invention a dental implant is provided that has a coronal portion at a first end, an apical portion at a second end, and middle portion between the coronal portion and the apical portion, wherein a longitudinal axis passes through the first end, the middle portion and the second end, wherein the apical portion and the middle portion are custom shaped to substantially conform to a specific tooth socket of a particular individual, and wherein the middle portion has a first portion proximate the coronal portion, the first portion having a circumferentially located ridge projecting substantially perpendicular to the longitudinal axis that is designed to fit into at least one notch cut into the specific tooth socket upon insertion of the apical portion into the specific tooth socket. The dental implant preferably has a plurality of circumferentially located ridges designed to fit into a plurality of notches cut into the specific tooth socket.

In another aspect of the invention a soft tissue pilot device is provided for removing soft tissue from a tooth socket in preparation for placing a dental implant comprising a pilot shaft, a pilot handle at a first end of the pilot shaft, a pilot tip at a second end of the pilot shaft, wherein a long axis of the pilot shaft extends through the pilot handle, the pilot shaft and the pilot tip, and a pilot cleaning blade attached to the pilot shaft and projecting perpendicular to the long axis of the pilot shaft, wherein the pilot cleaning blade is custom shaped to fit a specific tooth socket in a particular individual. The pilot cleaning blade is preferably beveled to form a cutting edge,

In yet another aspect of the invention an undercut pilot device is provided for placing notches in the walls of a tooth socket, comprising an undercut pilot shaft, an undercut pilot handle at a first end of the undercut pilot shaft, an undercut pilot tip stop at a second end of the undercut pilot shaft, wherein a long axis of the undercut pilot shaft extends through the undercut pilot handle, the undercut pilot shaft and the undercut pilot tip stop, a plurality of notching blades, a plurality of guide blades, wherein the notching blades and the guide blades are affixed to the undercut pilot shaft between the undercut pilot handle and the undercut pilot tip stop and project out from the undercut pilot shaft substantially perpendicular to the long axis of the undercut pilot shaft, wherein the notching blades and the guide blades are shaped to fit a specific tooth socket in a particular individual and wherein when the undercut pilot device is inserted as intended into the specific tooth socket each guide blade is just long enough to touch the walls of the specific tooth socket at the narrowest diameter and each notching blade is slightly longer than the guide blade so that it will cut into the walls of the specific tooth socket. Preferably, two notching blades and four guide blades are attached to the undercut pilot shaft.

In another aspect of the invention a dental implant is provided that is composed of more than one separate implant section, each implant section being custom shaped to substantially conform to at least one specific root void in a specific tooth socket of a particular individual, and each implant section being separable from the other implant sections to permit sequential insertion of the implant sections into the specific tooth socket, wherein when joined together, the implant sections form a dental implant that is shaped to substantially conform to the specific tooth socket.

In another aspect of the invention, a method of placing a dental implant in a tooth socket is provided comprising the following steps: 1) remove periodontal tissue from a tooth socket by inserting a soft tissue pilot and moving it translationally within the socket, 2) insert an undercut pilot into the tooth socket and rotate the undercut pilot more than 60 degrees until the undercut pilot rotates freely in the tooth socket, creating one or more notches in the walls of the tooth socket 3) insert an anatomically shaped implant having one or more ridges on its surface into the tooth socket, 4) apply pressure to engage the surface ridges on the anatomically shaped implant in the notches in the tooth socket.

In another aspect of the present invention a dental implant kit is provided comprising an anatomically shaped implant, one or more soft tissue pilots, and an undercut pilot.

In another aspect of the present invention a method of placing a dental implant in a multi-rooted tooth socket is provided, comprising: providing a tooth socket having two root voids, a first anatomically shaped implant section having a first implant coronal end and a second anatomically shaped implant section having a second coronal end, sequentially inserting the first anatomically shaped implant section and the second anatomically shaped implant section into the tooth socket, and joining the first implant coronal end and the second implant coronal end.

In another aspect of the present invention a method of placing a dental implant in a multi-rooted tooth socket is provided, comprising: providing a tooth socket having three root voids, a first anatomically shaped implant section having a first implant coronal end, a second anatomically shaped implant section having a second implant coronal end, a third anatomically shaped implant section having a third implant coronal end, sequentially inserting the first anatomically shaped implant section, the second anatomically shaped implant section, and the third anatomically shaped implant section into the tooth socket, and joining the first implant coronal end, the second implant coronal end and the third implant coronal end.

Another embodiment of the present invention encompasses a dental implant kit comprising at least two anatomically shaped implant sections, a soft tissue pilot, and an undercut pilot.

In another aspect of the present invention a method of implanting a single custom implant into a multi-rooted socket is disclosed in which the furcation bone is clipped between the multiple roots so that the portion of the implant in the vicinity of the furcation will be buried entirely in the bone subgingivally with a single custom implant.

In another aspect of the present invention, the custom implant could be stabilized for immediate loading with rotating cutting wings buried inside the implant, which will be engaged into the proximal walls by clockwise rotation with a wrench.

In another aspect of the present invention, a dental implant is provided, comprising: a first anatomically shaped implant section and a second anatomically shaped implant section, wherein the first anatomically shaped implant section can be reversibly joined to the second anatomically shaped implant section to form an anatomically shaped implant.

In another aspect of the present invention a dental implant is provided, comprising: a first anatomically shaped implant section, a second anatomically shaped implant section, and a third anatomically shaped implant section, wherein the first anatomically shaped implant section, the second anatomically shaped implant section, and the third anatomically shaped implant section can be reversibly joined to form an anatomically shaped implant.

In a specific embodiment of the present invention, the dental implant of either of the last two paragraphs is contemplated, wherein the anatomically shaped implant has a coronal end, and further comprising an abutment attached to the coronal end of the anatomically shaped implant so that the first anatomically shaped implant section, the second anatomically shaped implant section, and the third anatomically shaped implant section are all attached to the abutment.

In another aspect of the present invention, a dental implant is provided, comprising: a coronal portion at a first end, an apical portion at a second end, and middle portion between the coronal portion and the apical portion, wherein a longitudinal axis passes through the first end, the middle portion and the second end, wherein the apical portion and the middle portion are custom shaped to substantially conform to a specific tooth socket of a particular individual, and wherein the middle portion has a first portion proximate the coronal portion, the first portion having a circumferentially located ridge projecting substantially perpendicular to the longitudinal axis that is designed to fit into at least one notch cut into the specific tooth socket upon insertion of the apical portion into the specific tooth socket.

In another aspect of the present invention, a soft tissue pilot is provided, comprising: a pilot shaft, an pilot handle at a first end of the pilot shaft, a pilot tip at a second end of the pilot shaft, wherein a long axis of the pilot shaft extends through the pilot handle, the pilot shaft and the pilot tip, and a pilot cleaning blade attached to the pilot shaft and projecting perpendicular to the long axis of the pilot shaft, wherein the pilot cleaning blade is custom shaped to fit a specific tooth socket in a particular individual.

In yet another aspect of the present invention, an undercut pilot is provided, comprising: an undercut pilot shaft, an undercut pilot handle at a first end of the undercut pilot shaft, an undercut pilot tip stop at a second end of the undercut pilot shaft, wherein a long axis of the undercut pilot shaft extends through the undercut pilot handle, the undercut pilot shaft and the undercut pilot tip stop, a plurality of notching blades, and a plurality of guide blades, wherein the notching blades and the guide blades are affixed to the undercut pilot shaft between the undercut pilot handle and the undercut pilot tip stop and project out from the undercut pilot shaft substantially perpendicular to the long axis of the undercut pilot shaft, and wherein the notching blades and the guide blades are shaped to fit a specific tooth socket in a particular individual.

In still another aspect of the present invention, a dental implant kit is provided, comprising: an anatomically shaped implant, a soft tissue pilot; and an undercut pilot.

In another aspect of the present invention, a method of placing a dental implant section in a tooth socket is provided, comprising: providing a tooth socket, a soft tissue pilot, an undercut pilot and an anatomically shaped implant section having a coronal portion at a first end, an apical portion at a second end, and middle portion between the coronal portion and the apical portion, wherein a longitudinal axis passes through the first end, the middle portion and the second end, wherein the middle portion has a first portion proximate the coronal portion, the first portion having a circumferentially located ridge projecting substantially perpendicular to the longitudinal axis, removing excess soft tissue from said tooth socket by inserting said soft tissue pilot and moving it translationally within the socket, inserting said undercut pilot into the tooth socket and rotating the undercut pilot more than 60 degrees until the undercut pilot rotates freely in the tooth socket, to create a notch in the tooth socket; inserting said anatomically shaped implant section into the tooth socket, and applying pressure to seat said circumferentially located ridge on the anatomically shaped implant section in the notch in the tooth socket.

In yet another embodiment of the present invention, a method of placing an anatomically shaped implant in a multi-rooted tooth socket is provided, comprising: providing a multiple rooted tooth socket having a first root void and a second root void, a first anatomically shaped implant section shaped to substantially fit in said first root void, said first anatomically shaped implant section having a first implant coronal end, a second anatomically shaped implant section shaped to substantially fit into said second root void, said second anatomically shaped implant section having a second implant coronal end, and an abutment; positioning said first anatomically shaped implant section into said first root void; positioning said second anatomically shaped implant section into said second root void; joining the first implant coronal end and the second implant coronal end to the abutment to form an anatomically shaped implant. This method can be used to placed an anatomically shaped implant into a three rooted tooth socket wherein said multiple rooted tooth socket additionally has a third root void, and additionally providing a third anatomically shaped implant section shaped to substantially fit in said third root void, said third anatomically shaped implant section having a third implant coronal end, wherein said third anatomically shaped implant section is positioned in the third root void before the first implant coronal end and the second implant coronal end are joined to the abutment, after which the third implant coronal end is also joined to the abutment.

In another aspect of the present invention, a dental implant is provided comprising: a first anatomically shaped implant section and a second anatomically shaped implant section, wherein said first anatomically shaped implant section can be reversibly joined to said second anatomically shaped implant section to form an anatomically shaped implant.

In yet another aspect of the present invention said anatomically shaped implant has a coronal end, and further comprising an abutment attached to said coronal end of the anatomically shaped implant so that the first anatomically shaped implant section and the second anatomically shaped implant section are attached to the abutment.

In still another aspect of the present invention said first anatomically shaped implant section further comprises a first apical portion and wherein said first apical portion is shaped to generally conform to the contours of a root void in a specific tooth socket in an individual.

In another aspect of the present invention, said second anatomically shaped implant section further comprises a second apical portion and wherein said second apical portion is shaped to generally conform to the contours of a different root void of said specific tooth socket in said individual.

In another aspect of the present invention the dental implant further comprises: a third anatomically shaped implant section, wherein the first anatomically shaped implant section, the second anatomically shaped implant section, and the third anatomically shaped implant section can be reversibly joined to form an anatomically shaped implant.

In one embodiment, the anatomically shaped implant has a coronal end, and further comprising an abutment attached to the coronal end of the anatomically shaped implant so that the first anatomically shaped implant section, the second anatomically shaped implant section, and the third anatomically shaped implant section are all attached to the abutment.

In one embodiment at least one anatomically shaped implant section further comprises: a coronal portion at a first end, an apical portion at a second end, and middle portion between the coronal portion and the apical portion, wherein a longitudinal axis passes through the first end, the middle portion and the second end, wherein the apical portion and the middle portion are custom shaped to substantially conform to a specific tooth socket of a particular individual, and wherein the middle portion has a first portion proximate the coronal portion, the first portion having a circumferentially located ridge projecting substantially perpendicular to the longitudinal axis that is designed to fit into at least one notch cut into the specific tooth socket upon insertion of the apical portion into the specific tooth socket.

In another aspect of the present invention a method of placing a dental implant section in a tooth socket is contemplated, comprising: providing a tooth socket a soft tissue pilot, an undercut pilot and a first anatomically shaped implant section having a first coronal portion at a first end, an apical portion at a second end, and middle portion between the first coronal portion and the apical portion, wherein a longitudinal axis passes through the first end, the middle portion and the second end, wherein the middle portion has a first portion proximate the first coronal portion, the first portion having a circumferentially located ridge projecting substantially perpendicular to the longitudinal axis, removing excess soft tissue from said tooth socket by inserting said soft tissue pilot and moving it translationally within the socket, inserting said undercut pilot into the tooth socket and rotating the undercut pilot more than 60 degrees until the undercut pilot rotates freely in the tooth socket, to create a notch in the tooth socket; inserting said first anatomically shaped implant section into the tooth socket, and applying pressure to seat said circumferentially located ridge on the first anatomically shaped implant section in the notch in the tooth socket.

In one embodiment of the present method, said tooth socket comprises a first root void and a second root void, further providing: a second anatomically shaped implant section comprising a second coronal portion, wherein said first anatomically shaped implant section is inserted into said first root void and said second anatomically shaped implant is inserted in said second root void.

In another embodiment of the present method, further providing an abutment, wherein the first implant coronal portion and the second implant coronal portion are joined to the abutment.

In yet another embodiment said tooth socket further comprises a third root void, further providing: a third anatomically shaped implant section comprising a third implant coronal portion, wherein said third anatomically shaped implant is inserted in said third root void, and wherein the first implant coronal portion, the second implant coronal portion and the third implant coronal portion are joined to the abutment.

In a specific embodiment, further providing an abutment, the first implant coronal portion, the second implant coronal portion, and the third implant coronal portion are joined to the abutment.

The present invention contemplates a dental implant kit, comprising: an anatomically shaped implant, a soft tissue pilot; and an undercut pilot.

In one embodiment of the dental implant kit the soft tissue pilot comprises: a pilot shaft, an pilot handle at a first end of the pilot shaft, a pilot tip at a second end of the pilot shaft, wherein a long axis of the pilot shaft extends through the pilot handle, the pilot shaft and the pilot tip, and a pilot cleaning blade attached to the pilot shaft and projecting perpendicular to the long axis of the pilot shaft, wherein the pilot cleaning blade is custom shaped to fit a specific tooth socket in a particular individual.

In one embodiment of the dental implant kit, the undercut pilot comprises: an undercut pilot shaft, an undercut pilot handle at a first end of the undercut pilot shaft, an undercut pilot tip stop at a second end of the undercut pilot shaft, wherein a long axis of the undercut pilot shaft extends through the undercut pilot handle, the undercut pilot shaft and the undercut pilot tip stop, a plurality of notching blades, and a plurality of guide blades, wherein the notching blades and the guide blades are affixed to the undercut pilot shaft between the undercut pilot handle and the undercut pilot tip stop and project out from the undercut pilot shaft substantially perpendicular to the long axis of the undercut pilot shaft, and wherein the notching blades and the guide blades are shaped to fit a specific tooth socket in a particular individual.

In one embodiment of the dental implant kit said anatomically shaped implant comprises a dental implant having a coronal and an apical portion, wherein the apical portion of the dental implant is shaped to generally conform to the contours of a specific tooth socket in a particular individual.

These and other aspects of the present invention will become more apparent from the following detailed description of various embodiments of the present invention when viewed in conjunction with the accompanying drawings.

### DESCRIPTION OF THE FIGURES

The foregoing and other objects or features and advantages of the present invention will be made apparent from the following description of embodiments, although not exclusive, embodiments of the invention and from the drawings in which:

FIG. 1 is a cross-sectional view of an anatomically shaped implant assembly embedded into the natural tooth socket in the bone remaining after removal of a tooth.

FIG. 2 is a perspective view of a soft tissue pilot that may be used to remove periodontal tissue from the apical ⅓ of the tooth socket prior to an anatomically shaped implant of the present invention.

FIG. 3 is a perspective view of a soft tissue pilot that may be used to remove periodontal tissue from the middle ⅓ of the tooth socket prior to placing an anatomically shaped implant of the present invention

FIG. 4 is a perspective view of a soft tissue pilot that may be used to remove periodontal tissue from the coronal ⅓ of the tooth socket prior to placing an anatomically shaped implant of the present invention

FIG. 5 is a sectional view of an undercut pilot having cutting blades situated within a tooth socket which, when the undercut pilot is rotated, will place notches in the walls of the tooth socket prior to placement of an anatomically shaped implant of the present invention.

FIG. 6 is a sectional view of the undercut pilot of FIG. 5, having cutting blades situated within a tooth socket, which has been rotated from its initial position shown in FIG. 5 to place a notch in the tooth socket.

FIG. 7 is a perspective view of the undercut pilot shown in FIGS. 5 and 6.

FIG. 8 is a sectional view of a lower (mandibular) molar tooth socket containing two anatomically shaped implant sections joined by an abutment at their coronal end, where the first anatomically shaped implant section is placed in one of the two root voids in a tooth socket of a double-rooted tooth and the second anatomically shaped implant section is placed in the other root void.

FIG. 8A is a perspective view (from above) of the abutment depicted in FIG. 8, viewed in the direction shown by arrows 8A-8A, which is covering and is attached to the two anatomically shaped implant sections with screws.

FIG. 9 is a sectional view of a lower (mandibular) tooth socket containing the two anatomically shaped implant sections shown in FIG. 8, taken from the viewed from the opposite side than that shown in FIG. 8.

FIG. 10 is a sectional view of an upper (maxillary) first molar tooth socket, a triple rooted tooth socket, containing two of the three anatomically shaped implant sections, each placed in one of the visible root voids in the tooth socket, which are connected at their coronal end by an abutment with screws.

FIG. 11 is a sectional view of the triple rooted tooth socket shown in FIG. 10, viewed from the opposite side than that shown in FIG. 10, showing all three anatomically shaped implant sections which are joined together at their coronal ends and attached to an abutment with screws.

FIG. 11A is a perspective view (from below) of the abutment shown in FIG. 11, viewed in the direction shown by arrows 11A-11A, which is covering and is attached to the three anatomically shaped implant sections with screws.

FIG. 12 is a sectional view of an upper (maxillary) first or second bicuspid tooth socket containing a single anatomically shaped implant having two root projections that are formed anatomically to fit into the root projections of the tooth socket.

FIG. 13 is a sectional view of an upper (maxillary) first or second bicuspid tooth socket having root voids that are sufficiently different in path that two anatomically shaped implant sections have been placed in the root voids separately and then joined together at their coronal end by an abutment.

FIG. 14 is a sectional view of the cleaning blades shown in FIGS. 2, 3 and 4, in a tooth socket and positioned to remove soft tissue from the tooth socket.

FIG. 15 is a perspective view of an anatomically shaped implant section of the present invention embedded into the natural tooth socket in the bone remaining after removal of a tooth.

FIG. 16 is an enlarged cross section of View A from FIG. 15 showing the engagement of the ridges, in this case push-pull threads, into the socket wall.

FIG. 17 is a sectional view of an anatomically shaped implant section placed partially into a prepared tooth socket, showing the ridges on the anatomically shaped implant section and the notches on the proximal walls of the tooth socket. snap past the notches 62 creating the tug-back of the implant from the socket.

FIG. 18 shows a sectional view of the anatomically shaped implant section of FIG. 17 having been fully inserted into the tooth socket with the ridges on the anatomically shaped implant section seated in the notches on the proximal walls of the tooth socket.

FIG. 19 shows a sectional view of the anatomically shaped implant section of FIGS. 17 and 18 fully inserted into the tooth socket with a healing cap attached.

### DETAILED DESCRIPTION OF THE PREFERRED EMBODIMENTS

The following is a list of reference numerals used throughout:

REFERENCE NUMERALS

| | |
|---|---|
| 10 | Anatomically shaped implant |
| 12 | Healing cap |
| 13 | Abutment |
| 14 | Screw |
| 16 | Coronal end |
| 18 | Jaw bone |
| 20 | Tooth socket |
| 22 | Soft tissue pilot |
| 24 | Pilot shaft |
| 26 | Pilot handle |
| 28 | Pilot tip |
| 30 | Cleaning blade |
| 32 | Apical portion of the tooth socket |
| 34 | Middle portion of the tooth socket |
| 36 | Coronal portion of the tooth socket |
| 38 | Undercut pilot |
| 40 | Undercut pilot shaft |
| 42 | Undercut pilot handle |
| 44 | Undercut pilot tip stop |
| 46 | Notching blade |
| 48 | Guide blade |
| 50 | Notching blade projection |
| 52 | Anatomically shaped implant section |
| 54 | Crown |
| 56 | Root projection |
| 58 | Soft tissue |
| 60 | Ridges |
| 62 | notches |
| 64 | Push pull threads |
| 66 | Socket wall |

Recent improvements in imaging technology permit the simple and rapid modeling of an implant that is custom shaped to fit into the alveolar socket of a patient, in some cases even before the tooth to be replaced has been removed. Because of the increased bone contact between a custom shaped implant and the tooth socket, as well as because of the commonly ovoid shape of tooth sockets, it is possible, with an improved system to prevent translational movement of the implant out of the socket, to securely place an implant in a tooth socket without the necessity of drilling into the bone to secure the implant with a screw.

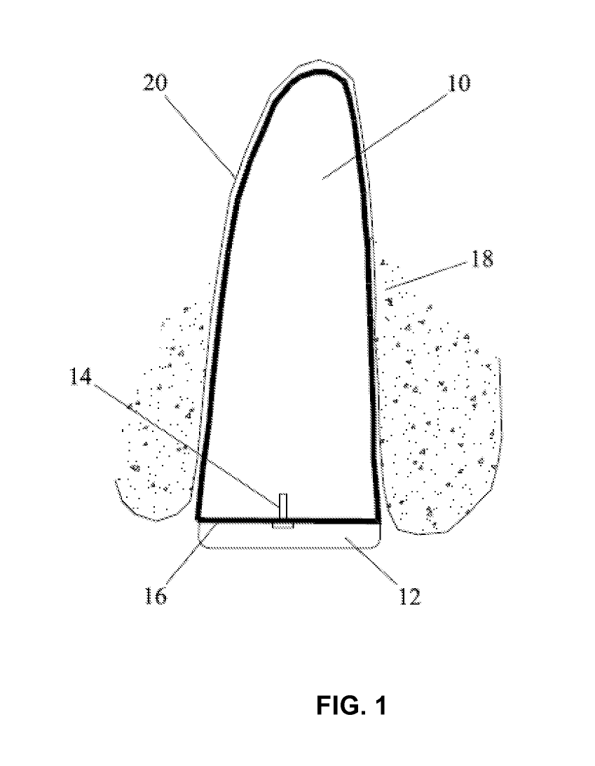

Referring now to the drawings and, in particular, to FIG. 1, wherein is shown a sectional view of an embodiment of the present invention, a anatomically shaped implant 10, having a healing cap 12 held in place by a screw 14 placed on the coronal end 16 of the anatomically shaped implant 10, which is embedded within the jaw bone 18 in a tooth socket 20 left by a previously removed tooth. The figure shows that the anatomically shaped implant 10 is an approximate replica of the void formed by the tooth socket.

In one embodiment the anatomically shaped implant is placed within a couple weeks after extraction. In another embodiment, if the anatomically shaped implant can be fabricated before the extraction of the tooth, the implant is placed immediately after the extraction.

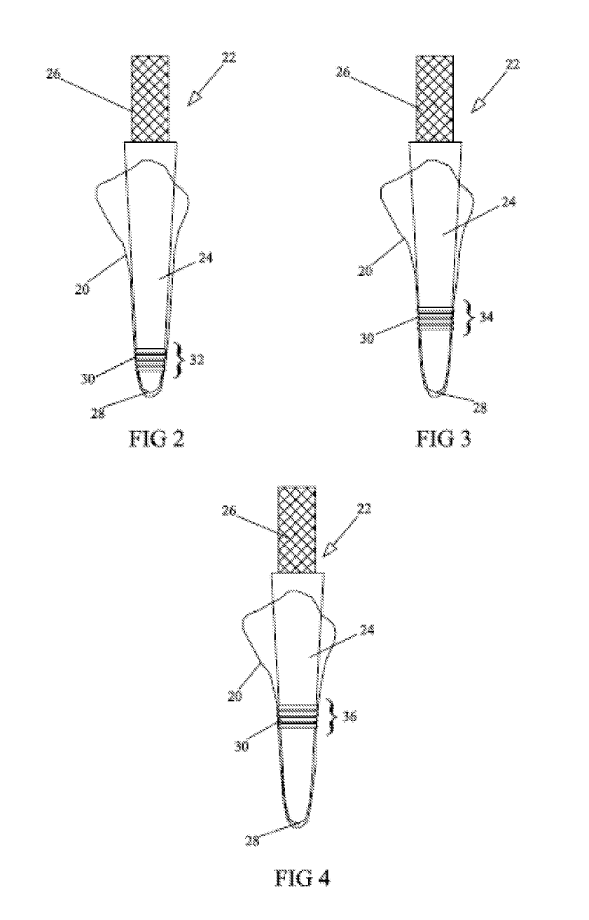

Natural teeth are typically not in direct contact with the bone of the socket, but are connected to the bone by ligaments, referred to as the periodontal ligament or “PDL.” Root implants, on the other hand, rely in part on osseointegration to stabilize them within the tooth socket. In order to encourage osseointegration of an implant, any periodontal ligament or other periodontal tissue remnant is preferably removed from the socket prior to placing an implant. FIGS. 2, 3 and 4 are perspective views of soft tissue pilots 22 of the present invention that may be used to remove the periodontal ligament and other soft tissue from the tooth socket 20 prior to placement of an anatomically shaped implant of the present invention. The soft tissue pilot 22 comprises a pilot shaft 24, a pilot handle 26 at one end of the pilot shaft 24, a pilot tip 28 at the other end of the pilot shaft 24, wherein a long axis of the pilot shaft 24 extends along the pilot shaft 24 between the pilot handle 26 and the pilot tip 28, and one or more pilot cleaning blades 30 to debride soft tissue from the bone that forms the tooth socket 20. The cleaning blades 30 encircle the pilot shaft 24, projecting perpendicular to the long axis of the pilot shaft 24. Each cleaning blade 30 is beveled to form a cutting edge. After extraction of the natural tooth the soft tissue pilot 22 is placed in the tooth socket 20 and is moved translationally within the tooth socket 20 to remove existing periodontal tissue, including the periodontal ligament. In a preferred embodiment of the present invention, the pilot tip 28 and at least a portion of the pilot shaft 24 of the soft tissue pilot 22 is anatomically shaped to fit the tooth socket.

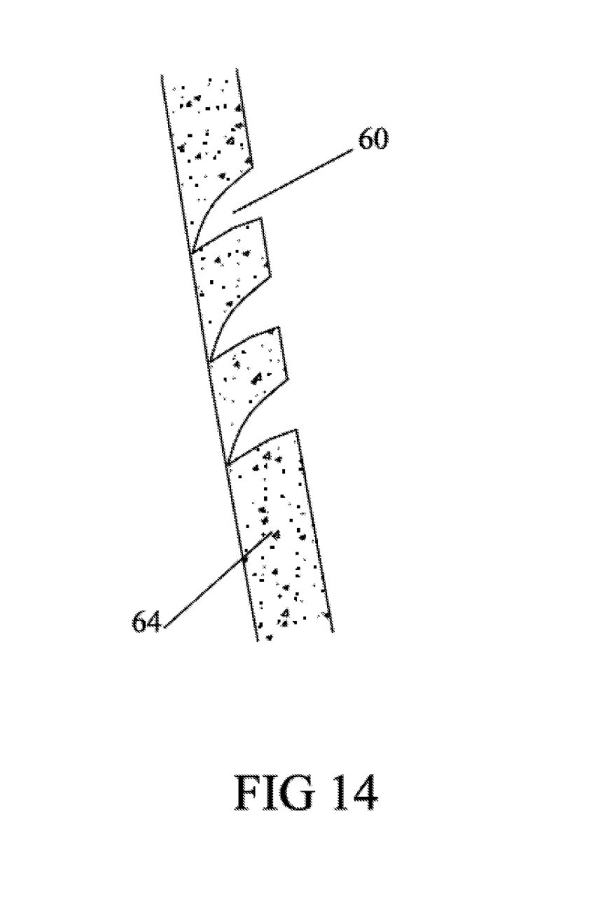

In one embodiment of the present invention, a series of soft tissue pilots 22 are used sequentially to remove periodontal tissue from different portions of the tooth socket 20. Each soft tissue pilot 22 is designed to remove tissue from a certain portion of the tooth socket 20 by positioning and sizing the cleaning blades 30 to remove tissue from only the target area. For example, in FIG. 2 the soft tissue pilot 22 is designed to remove tissue from the apical portion of the tooth socket 32. In a specific embodiment, the cleaning blades 30 in FIG. 14 have reverse push-pull threading that functions to remove soft tissue 58 when the translational force is in the apical direction, to prevent the soft tissue pilot 22 from becoming lodged in the socket during insertion, and to block the soft tissue pilot from insertion so far that the pilot tip 28 or pilot shaft 24 could cause damage to the jaw bone.

By isolating the area upon which each soft tissue pilot acts as well as by limiting the insertion with push pull threads; the chance of fracture of the buccal cortical bone plate that could result from clinicians handling the soft tissue pilot 22 too aggressively is reduced. Further, push pull threads permit removal of the periodontal tissue while reducing the likelihood that the socket cortical bone will be altered.

The soft tissue pilots 22 shown in FIGS. 2, 3 and 4 are designed for removal of periodontal tissue from the apical, middle, and coronal portions of the tooth socket 20, respectively, by placing the cleaning blades 30 on the pilot shaft 24 either toward the apical, middle or coronal portion of the pilot shaft 24 that fits within the tooth socket when fully inserted.

In the embodiments shown in FIGS. 2-4, each cleaning blade 30 of the soft tissue pilot 22 encircles the pilot shaft 24, projecting perpendicular to the long axis of the pilot shaft 24. Each cleaning blade 30 is beveled to form a cutting edge that encircles the pilot shaft 24. However, any other configuration that will remove periodontal tissue upon movement of the soft tissue pilot 22 is contemplated for use in the soft tissue removal step of the present invention, including, without limitation, reverse push pull blades seen in FIG. 14.

Each soft tissue pilot 22 will mimic the shape of the custom implant in that portion of the socket for which it is designed to operate. For example, the apical portion of the soft tissue pilot 22 made to remove tissue from the apical portion of an individual tooth socket will be shaped substantially like the morphology of the apical area of the tooth socket of the individual for whom it is designed. In a preferred embodiment, other portions of the pilot are smaller than the corresponding portion of the tooth socket so that these portions do not engage the wall during the preparation of the socket. Similarly, the middle portion of the soft tissue pilot 22 made to remove tissue from the middle portion of an individual tooth socket will be shaped substantially like the morphology of the middle area of the tooth socket of the individual for whom it is designed, and the apical and coronal portions are preferably smaller than that of the tooth socket. It follows that the coronal portion of the soft tissue pilot 22 made to remove tissue from the coronal portion of an individual tooth socket will be shaped substantially like the morphology of the coronal area of the tooth socket of the individual for whom it is designed, and preferably the apical and the middle portions of the soft tissue pilot 22 are smaller than that of the tooth socket. This way, the intended pilot engages, removes tissue from and prepares the tooth socket only within in the portion it is intended to work. After preparing the tooth socket with the pilots, the implant should fit well into the tooth socket. In the case of multiple rooted teeth, in a preferred embodiment a soft tissue pilot is prepared for the apical, middle and coronal portions of each individual root to ensure the fitting of each individual anatomically shaped implant section into its root void prior to assembly of each section using an abutment or healing cap anchored by screws.

If it is not necessary to place a restorative tooth immediately, then when the anatomically shaped implant 10 has been fabricated and the periodontal ligament and other periodontal tissue have been removed from the tooth socket, the anatomically shaped implant 10 may be seated, a healing cap may be placed over it and the anatomically shaped implant may then be sutured in place using either a resorbable or non-resorbable membrane to cover. The anatomically shaped implant 10 may be retrieved after sufficient osseointegration has taken place, generally in three to five months. An abutment is then fixed on the anatomically shaped implant 10 to hold a restorative tooth.

In order to have primary retention for the anatomically shaped implant in the tooth socket, in one embodiment of the present invention notches are cut in the walls of the tooth socket by use of an undercut pilot prior to seating an anatomically shaped implant. In this embodiment, the anatomically shaped implant is also fabricated to have one or more ridges on its proximal surfaces that project slightly beyond the diameter of the natural dimension of the tooth socket where the implant ridge will rest upon placement of the implant in the socket and that are complementary to the notches. In a preferred embodiment the ridges on the proximal surfaces of the anatomically shaped implant are parallel threads. The anatomically shaped implant can then be placed in the socket with enough pressure to seat the ridges into the notches, which junction will act to provide stability and retention for the anatomically shaped implant during osseointegration. In this embodiment the anatomically shaped implant is preferably shorter than the tooth socket length at the apical portion to allow apical movement for the ridges to latch into the prepared notches on the proximal walls.

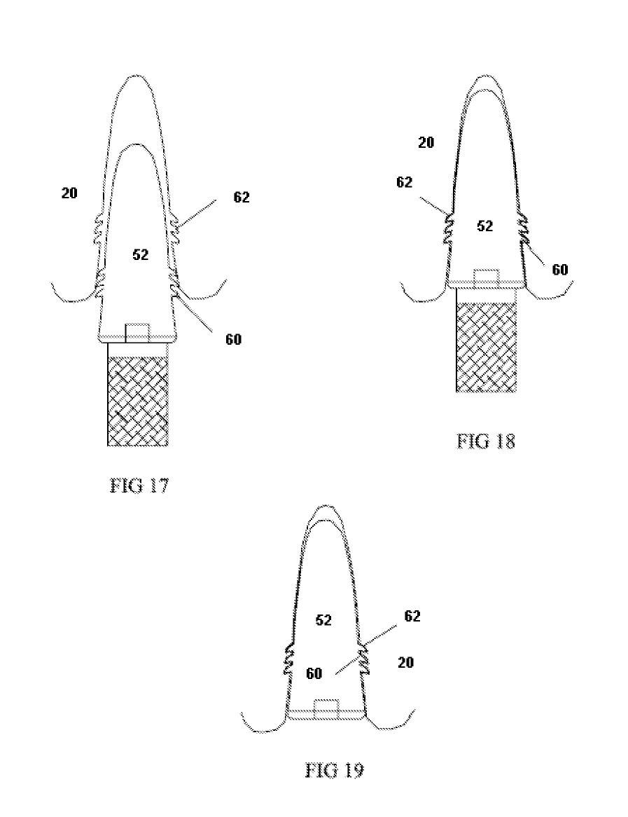

In FIG. 17, the anatomically shaped implant section 52 is placed into the prepared tooth socket 20. When it touches the socket wall, light pressure is applied until the ridges 60 snap past the notches 62 creating the tug-back of the implant from the socket. FIG. 18 shows the anatomically shaped implant section 52 seated completely inside the tooth socket 20. The anatomically shaped implant section 52 shown in FIG. 17 has been pushed lightly until the ridges 60 are engaged into the notches 62 created by the undercut pilot to position the anatomically shaped implant section 52 as shown in FIG. 18. FIG. 19 shows the anatomically shaped implant section 52 in place with a healing cap attached.

Although the use of ridges seated in notches is a preferred arrangement for providing stability to the anatomically shaped implant section 52, in another embodiment the anatomically shaped implant section 52 is made with parallel concentric threads on its proximal surface to provide a tug-back effect without using the undercut notches discussed above. The threaded implant has the push-pull parallel threads to allow apical placement but prevent coronal movement once these threads engaged into the tooth socket wall following placement using apical pressure.

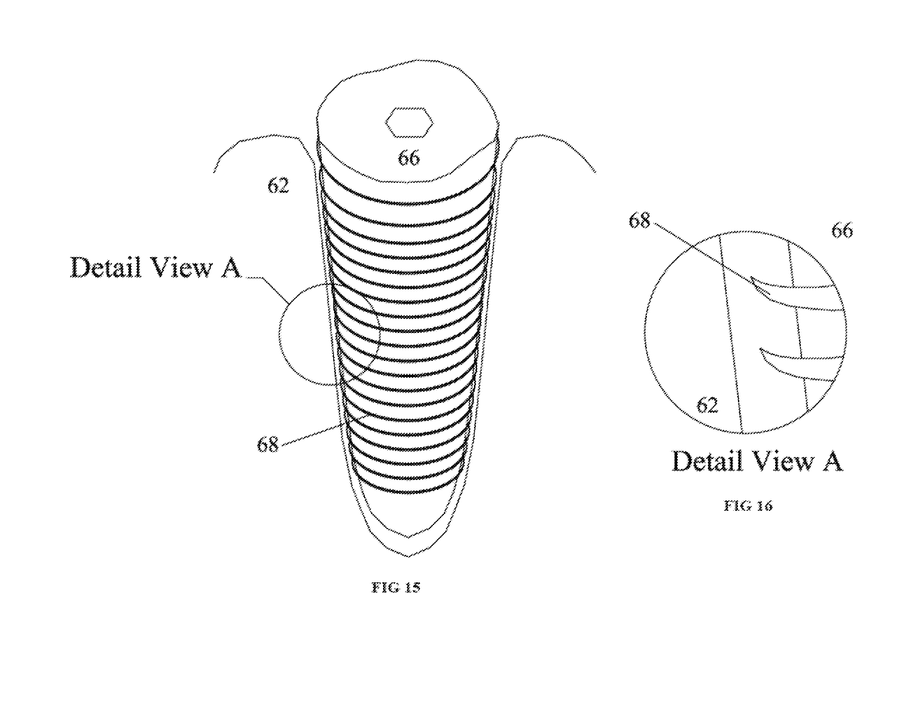

FIG. 15 shows an anatomically shaped implant section 52 having ridges having the shape in this embodiment of push pull threads 64, parallel to each other and concentric, seated in a tooth socket 20 with push pull threads 64 engaging into the socket wall 66. FIG. 16 shows the enlargement of View A, elucidating the engagement of the push-pull threads 64 into the socket wall 66.

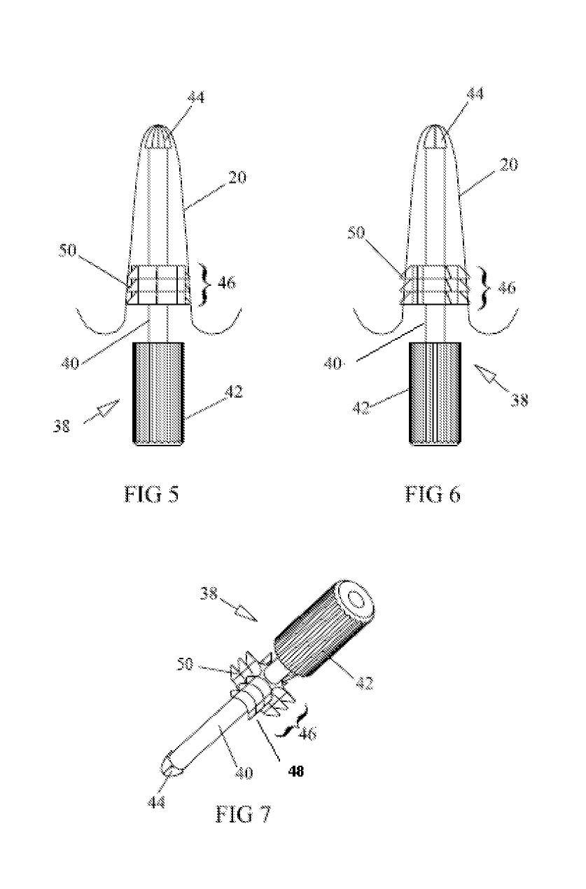

FIGS. 5 and 6 are sectional views and FIG. 7 is a perspective view of an undercut pilot 38 of the present invention that may be used to cut parallel notches in the walls of tooth socket as described herein. The undercut pilot 38 comprises an undercut pilot shaft 40, an undercut pilot handle 42, an undercut pilot tip stop 44, wherein a long axis of the undercut pilot shaft 40 extends along the undercut pilot shaft 40 between the undercut pilot handle 42 and the undercut pilot tip stop 44, two or more notching blades 46 to cut notches in the walls of the tooth socket 20, and two or more guide blades 48 (visible in FIG. 7 only) that are shaped to just contact the narrowest dimension of the root cross section when the undercut pilot 38 is inserted fully into the tooth socket.

To create notches in the tooth socket 20, the undercut pilot 38 is placed in the tooth socket 20 and is moved rotationally within the tooth socket 20, preferably rotating the undercut pilot back and forth by more than 60 degrees, until the notching blades 46 remove sufficient bony material from the sides of the tooth socket to create one or more notches. Without limiting the invention to any particular shape of notching blade, the notching blades 46 shown in FIGS. 5, 6 and 7 are shaped to create a notch in the tooth socket that is undercut so that a push-pull threat on an anatomically shaped implant section will seat securely in the notch created by the notching blades 46. Creating an undercut shaped notch in the tooth socket to match push-pull threads on the anatomically shaped implant section is useful in particular for single-rooted tooth applications to provide more initial retention for the implant when immediate placement after extraction is performed. Although the same technique can be used in multiple rooted tooth applications, it may not be as preferable in some multiple rooted tooth applications because the inherent mechanical retention resulting from having different paths of withdrawal for each of the individual anatomically shaped implant sections from separate root voids already provides sufficient retention.

Each notching blade 46 and each guide blade 48 are affixed to the undercut pilot shaft 40 between the undercut pilot handle 42 and the undercut pilot tip stop 44 and project perpendicular to the long axis of the undercut pilot shaft 40. In the embodiment shown in FIGS. 5, 6 and 7, the undercut pilot 38 has two guide blades 48 (shown in FIG. 7) which are just long enough to be in contact with the narrowest portion of the root cross section, and four notching blades 46 having slighter bigger diameter than the narrowest portion of the root cross section to generate an undercut pattern of parallel notches in the mesio-distal walls of the tooth socket when the undercut pilot 38 is rotated in the socket. In a preferred embodiment, the notching blades 46 are approximately 0.2-0.4 mm bigger than the guide blades 48.

In one embodiment, as shown in FIGS. 5, 6 and 7, each notching blade 46 has three notching blade projections 50 each of which cuts a separate notch in the tooth socket when the undercut pilot 38 is rotated, in this particular embodiment creating three threads in the tooth socket. In a preferred embodiment, each notching blade 46 has a plurality of notching blade projections 50.

For most single rooted teeth the mesio-distal dimension is smaller than bucco-lingual dimension. Thus, the notch pattern created by rotation of the undercut pilot 38 of the present invention in the tooth socket will be placed on the mesial and distal cortical bone of most tooth sockets, avoiding damage to the thin buccal cortical bone plate.

The retention of the implant is achieved by the mechanical engagement of the ridges and notches together with the friction between the implant and cortical bony wall socket. Surface tension resulting from blood and fluid in the space between the implant and the socket provide additional retention. For an implant that does not have sufficient initial retention, in a preferred embodiment it is buried under the soft tissue during the osseointegration period.

In a preferred embodiment, notches are placed along ⅓ to ½ of the root length of the tooth socket 20 prior to placement of the anatomically shaped implant.

In one embodiment of the present invention, ridges that are intended to fit into the notches that have been or will be placed in the walls of the tooth socket using the undercut pilot 38 are placed on the corresponding proximal surfaces of the anatomically shaped implant. In a preferred embodiment the ridges on the proximal surfaces of the anatomically shaped implant are substantially parallel to each other. When the anatomically shaped implant is inserted into the tooth socket a light pressure may be needed to push the thread on the anatomically shaped implant past the notches in the tooth socket. Once the anatomically shaped implant is pressed into the tooth socket until the threads on the anatomically shaped implant pass the notches in the tooth socket, the butt-joint created between the anatomically shaped implant threads and the notches in the tooth socket will give the implant primary translational stability.

The clinician may then perform a tug back test on the anatomically shaped implant to ensure that the threads are properly seated in the notches. A periapical x-ray may also be used to confirm the seating of the implant. Provisional restoration may then be placed out of occlusal load for the initial period of osseointegration. Once threads on the anatomically shaped implant are seated in the notches in the walls of the tooth socket 20, the anatomically shaped implant will resist translational movement out of the socket. Additionally, because the natural shape of tooth sockets is seldom symmetrical, the anatomically shaped implant should not be able to rotate within the tooth socket 20. In one embodiment, restoration or prosthesis is performed after the normal osseointegration period of 3-5 months or less.

By employing ridges on the anatomically shaped implant and notches in the tooth socket 20 the acceptable margin of error in the precision of the anatomically shaped implant dimension when compared to the tooth socket dimension is increased. In a preferred embodiment the anatomically shaped implant is approximately 1-2 mm shorter than the tooth socket 20 depth to facilitate complete seating & tug back effect.

In the case of teeth having multiple roots, if the tooth can be extracted from its socket in one piece with all roots remaining intact and without damaging the tooth socket, then it may be possible to place an anatomically shaped implant into the tooth socket in one piece without drilling. However, for teeth having multiple roots which generally have different path of removal, such as upper first bicuspids and lower first molars, it may not be possible to place an anatomically shaped implant into the tooth socket in one piece without drilling because the root paths differ enough to prevent insertion of both root portions of the anatomically shaped implant at once.

The present invention encompasses anatomically shaped implant sections that can be inserted into the tooth socket sequentially and then joined together at the coronal end to form a complete anatomically shaped implant after the sections have been positioned in the socket. As an additional benefit, by setting at least two anatomically shaped implant sections at an angle with respect to each other, and then fixing the coronal ends of the anatomically shaped implant sections, the anatomically shaped implant sections are thus anchored in the jaw immediately upon placement, due to the geometry of the root positions.

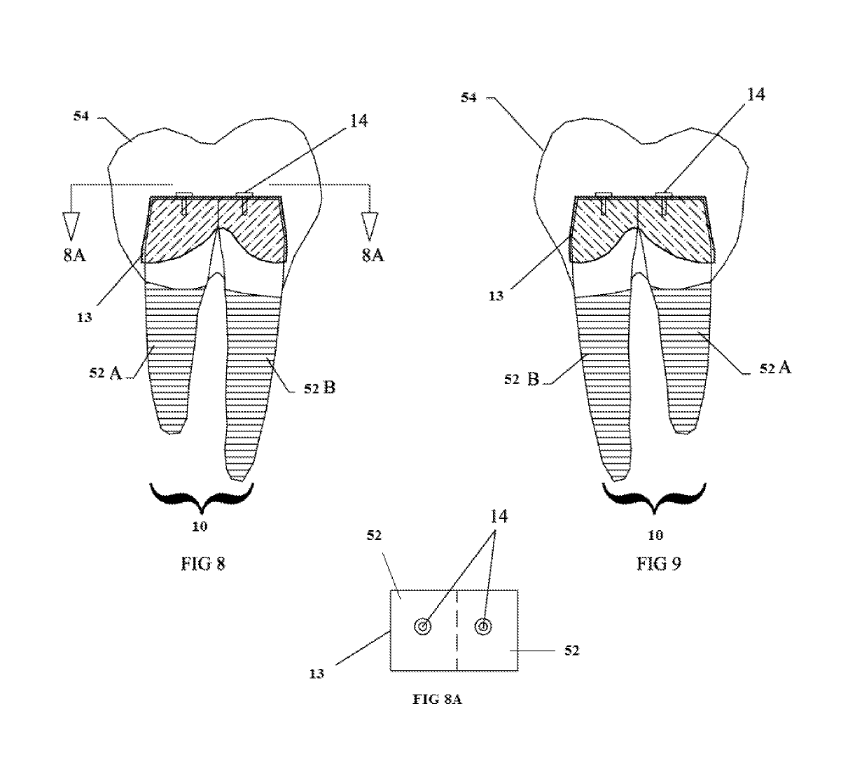

FIG. 8 is a sectional view of a lower (mandibular) tooth socket containing two anatomically shaped implant sections 52A and 52B, the first anatomically shaped implant section 52A placed in one of the two root voids in a tooth socket of a double-rooted tooth and the second anatomically shaped implant section 52B placed in the other root void. The anatomically shaped implant sections 52 are connected at their coronal end by an abutment 13 to secure them together. The abutment 13 is fitted with two screws 14, one that attaches the abutment 13 to each anatomically shaped implant section 52A and 52B. A crown 54 is placed on the abutment 13.

The anatomically shaped implant sections 52 can either be obtained by fabricating each anatomically shaped implant section 52 separately or by fabricating an anatomically shaped implant 10 and then dividing it into more than one anatomically shaped implant section 52 prior to insertion into the tooth socket.

In a preferred embodiment for single-rooted teeth the anatomically shaped implant section 52 is buried under the soft tissue during the osteo-integration phase. The implant therefore will be as long as the bone crest with a healing cap 12 placed in order to be covered by the soft tissue after placement. Similarly, some multi-rooted tooth applications can be converted for the use of a single-rooted anatomically shaped implant section by clipping the furcation bone to facilitate a single path of insertion and withdrawal. In a preferred embodiment, for multi-rooted teeth with different paths of withdrawal for separate roots, the anatomically shaped implant sections 52 will be longer than the socket so that the coronal parts of these implants can be held together by the abutment with screw right after the placement as well as during the integration. If the retention is sufficient, immediate restoration can be made without occlusal loading.

In another embodiment, the anatomically shaped implant sections 52 that together make a complete anatomically shaped implant 10 are designed so that each the anatomically shaped implant section 52 reversibly connects to the other the anatomically shaped implant section 52 or sections by means of complementary slots cut into the anatomically shaped implant sections 52.

FIG. 8A is a perspective view (from above) of the abutment 13 depicted in FIG. 8, viewed in the direction shown by arrows 8A-8A, which is covering and is attached to the two anatomically shaped implant sections 52 with screws 14. The dotted line represents the location where the two anatomically shaped implant sections 52 meet beneath the healing cap 12 or abutment 13.

FIG. 9 is a sectional view of a lower (mandibular) tooth socket containing the two anatomically shaped implant sections 52 shown in FIG. 8, viewed from the opposite side than that shown in FIG. 8.

In the case of double rooted teeth, the anatomically shaped implant 10 would preferably comprise two separate anatomically shaped implant sections 52. In some triple rooted teeth, two of the roots may be oriented with respect to each other to permit insertion of both roots at once, in which case two anatomically shaped implant sections 52, one with one root and one with two roots, would be sufficient. However, for some teeth, such as upper first molars, which have three paths of removal for three separate roots: mesio-buccal, disto-buccal and palatal, in one embodiment of the present invention, an anatomically shaped implant 10 for use in triple rooted teeth will comprise three separate anatomically shaped implant sections 52. The coronal end of the implant may be divided similarly to a bi-rooted tooth to allow sequential placement of three anatomically shaped implant sections. Each section can then be tied together by an extra-coronal circumferential abutment with screws or slots.

Because of the different paths of insertion, an anatomically shaped implant formed by the joining of multiple anatomically shaped implant sections is expected to have additional mechanical retention. One benefit of this stability is that it may not be necessary to bury the implant during the initial period of osseointegration. However, additional stabilizing of individual implant sections as well as stabilizing of the complete anatomically shaped implant may still be implemented as described herein for one piece anatomically shaped implants.

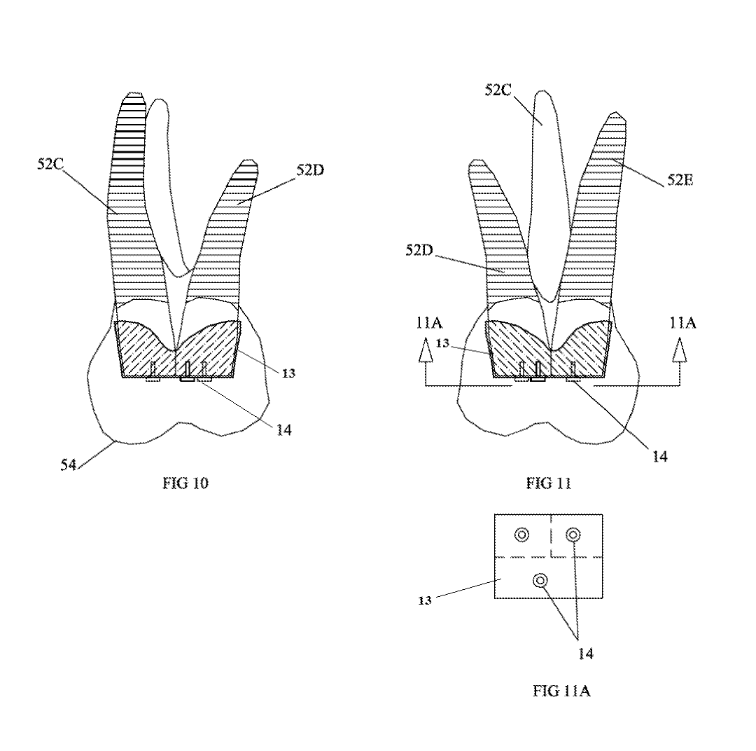

FIG. 10 is a sectional view of an upper (maxillary) first molar tooth socket, a triple rooted tooth socket, containing two of the three anatomically shaped implant sections 52C and 52D, each placed in one of the visible root voids in the tooth socket. An abutment 13 is connected to the coronal end of the anatomically shaped implant sections 52 by screws 14. A crown 54 is placed on the abutment 13.

FIG. 11 is a sectional view of the triple rooted tooth socket shown in FIG. 10, viewed from the opposite side than that shown in FIG. 10, showing all three anatomically shaped implant sections 52C, 52D, and 52E, which are joined together at their coronal ends and attach to the abutment 13 with screws 14. A crown 54 is placed on the abutment 13.

FIG. 11A is a perspective view (from below) of the abutment shown in FIG. 11, viewed in the direction shown by arrows 11A-11A, which is covering and is attached to the three anatomically shaped implant sections 52C, 52D and 52E with screws 14. The dotted line represent the locations where the three anatomically shaped implant sections 52 meet beneath the abutment 13

In a preferred embodiment, the furcation area of the anatomically shaped implant for a multi-rooted tooth socket, whether in the form of a single implant or in the form of more than one anatomically shaped implant section joined together, will be formed to rest between 4-5 mm above the furcation bone crest when positioned in the tooth socket. As normal periodontal tissue thickness is approximately 3 mm, it is believed that this will facilitate healing in the furcation area.

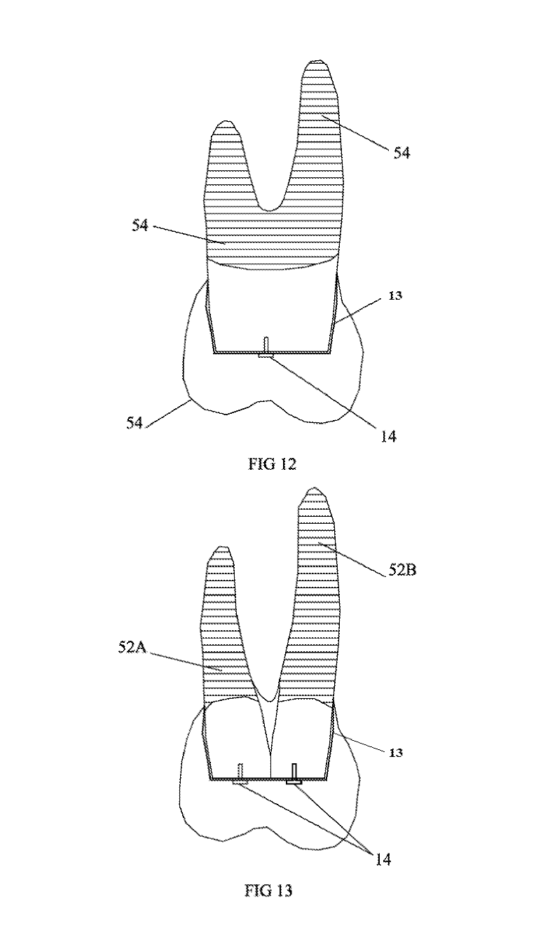

FIGS. 12 and 13 show an upper (maxillary) first or second bicuspid tooth socket. The figures show two forms of double rooted tooth sockets. In FIG. 12 the orientation of the two root voids permits the insertion of an intact anatomically shaped implant 10 having two root projections 56 that are formed anatomically to fit into the root voids of the tooth socket of a maxillary first bicuspid. Because the root voids are substantially parallel, the anatomically shaped implant 10 does not need to be formed in two sections prior to insertion.

FIG. 13, on the other hand, is a sectional view of a double rooted tooth socket having root voids that are sufficiently different in path that two anatomically shaped implant sections 52A and 52B have been placed in the root voids separately and are joined together at their coronal end with an abutment 13. The abutment 13 is again fitted with screws 14, one that attaches the abutment 13 to each anatomically shaped implant section 52A and 52B. A crown 54 is fixed on the abutment 13, completing the restoration.

In one embodiment of the present invention, a method of placing a dental implant in a tooth socket is provided comprising the following steps: 1) remove periodontal tissue from a tooth socket by inserting a soft tissue pilot and moving it translationally within the socket, 2) insert an undercut pilot into the tooth socket and rotate the undercut pilot more than 60 degrees until the undercut pilot rotates freely in the tooth socket, creating one or more notches in the walls of the tooth socket 3) insert an anatomically shaped implant having one or more ridges on its surface into the tooth socket until resistance is felt, 4) apply pressure to engage the surface ridges on the anatomically shaped implant in the notches in the tooth socket, 4) pull back on the anatomically shaped implant to establish that the implant is anchored in the tooth socket. The clinician may alternatively take a periapical x-ray to confirm the seating of the implant. In a preferred embodiment the clinician then installs a provisional restoration, which, is out of occlusal load for the success of osseointegration, and then, after the normal osseointegration period of 3 to 5 months, installs the final restoration. In an alternative embodiment, the clinician installs the final restoration immediately upon placing the implant

Once the anatomically shaped implant is seated past the undercut in the tooth socket, it resists translate out of the socket due to the creation of a butt joint between the implant ridge and the undercut. Additionally, the anatomically shaped implant resists rotation because it is not symmetrical, unlike most currently available implants.

One embodiment of the present invention encompasses a dental implant kit comprising an anatomically shaped implant, one or more soft tissue pilots, and an undercut pilot if necessary.

Another embodiment of the present invention encompasses a dental implant kit comprising at least two anatomically shaped implant sections, soft tissue pilots. In a preferred embodiment of the present invention, the dental implant kit also comprises a model of a tooth socket for which the anatomically shaped implant is intended to be placed. A clinician can use the model to practice the sequence, angulation and the orientation of placement of each anatomically shaped implant section. After familiarized with the dental implant kit, the clinician can remove the PDL and the connected tissue using the soft tissue pilot.

In another embodiment of the present invention, a method of placing a dental implant in a multi-rooted tooth socket is provided comprising the following steps: 1) remove periodontal tissue from a tooth socket using a soft tissue pilot, 2) sequentially insert at least two anatomically shaped implant sections into the tooth socket, and 4) join the coronal ends of the anatomically shaped implant sections by attaching an abutment. The clinician may take a periapical x-ray to confirm the seating of the implant. In a preferred embodiment the clinician then installs a provisional restoration, which, is out of occlusal load for the success of osseointegration, and then, after the normal osseointegration period of 3 to 5 months, installs the final restoration. In an alternative embodiment, the clinician installs the final restoration immediately upon placing the implant

Fabrication of an Anatomically Shaped Implant of the Present Invention

An anatomically shaped implants and anatomically shaped implant sections can be fabricated in a number of ways known in the art. The dimensions of the socket or root can be obtained by several known means, including, without limitation to any method of determining dimensions, 1) obtaining a 3-dimentional image using cone beam technology (imaging equipment available from Sirona™, Charlotte, N.C.; Kodak™, Atlanta, Ga.; or Gendex™, Des Plaines, Ill.) while the tooth is still in place, 2) modeling the implant shape using the extracted tooth itself if the root morphology is preserved in the extracted tooth, or 3) obtaining an impression of the socket after extraction, either with conventional impression materials such as, without limitation, alginate or hydrophilic polyvinylsiloxane (PVS), or by obtaining the dimensions of the socket using 3-dimensional digital scan technology. U.S. patent application Ser. Nos. 11/724,261 and 11/549,782 (Rubbed), have a detailed description from which one may obtain guidance regarding how to make an implant that substantially conforms to the three dimensional surface of a root of a tooth to be replaced.

The anatomically shaped implant or anatomically shaped implant sections can be composed of any resilient material that is nontoxic to humans or to the particular mammal the implant is to be made for, but preferably comprises a titanium alloy.

CAD-CAM software can be used to copy-mill or cast a one piece implant once the dimensions and desired surface treatments, if any, are determined.

An anatomically shaped implant for installation in a multi-rooted tooth socket can be manufactured in sections or can be manufactured in one piece and then divided after manufacture. Although preferred planes for the division or divisions that divide an anatomically shaped implant into multiple anatomically shaped implant sections, as well as the sequence of placement of those sections, can be determined without the aid of a computer, in a preferred embodiment CAD-CAM software is used to partition an anatomically shaped implant of the present invention into separate anatomically shaped implant sections and to ascertain the preferred sequence of placement of each section. Factors such as the root morphology as well as constraints from the rest of the dentition and the surrounding soft tissue are preferably factored into the determination of partitioning and sequence of placement. The preferred partition will provide the easiest path of insertion for each anatomically shaped implant section.

In one embodiment of the present invention, when the shape of the tooth socket is determined, this information may also be used in forming an anatomically shaped soft tissue pilot 22, whereby that the portion of the soft tissue pilot 22 that is inserted into the tooth socket, including the pilot tip 28 and at least a portion of the pilot shaft 24, approximates the shape of the tooth socket. Additionally, the dimensions of the tooth socket may also be used in fabricating an undercut pilot 38 to determine the desired length of the guide blade 48 and the notching blade 46.

Surface Treatments of an Anatomically Shaped Implant

In some cases it may be desirable to increase the initial retention of an implant or to encourage the speed of osseointegration after implantation. Thus, in an embodiment of the present invention, the surface of the anatomically shaped implant has one or more features that improves retention or encourages osseointegration.

Anatomically shaped implants of the present invention can additionally have at least one surface configuration that increases the outer surface area that will, including, but not limited to: a roughened outer surface, such as that created by machining, grit-blasting, etching, plasma spraying, or any other method of roughening the surface material of the implant; ribs, including without limitation parallel ridges or helical threads; pores. Such surface roughening is believed to encourage osseointegration of the implant.

The anatomically shaped implants of the present invention can have a threaded outer surface, which threads can comprise, without limitation, parallel or helical threads. The thread patterns that can be varied depending on how much initial retention is needed.

In one embodiment, the surface of an anatomically shaped implant of the present invention is coated with a biocompatible osseoconductive material to aid osseointegration of the implant in the jaw bone.

After implantation, there is a period of time over which osseointegration occurs, increasing stability of the implant. The anatomically shaped implant of the present invention may be constructed as a one-piece implant which is intended to be exposed to the oral cavity during the osseointegration period, or as two-piece implant system, where the root portion of the implant is placed in the socket and buried under the soft tissue during the osseointegration period, after which it is uncovered and an abutment that will act as a platform for attachment of the restorative phase is affixed to the implant. The restorative phase artificial tooth is then attached to the abutment by any known means, including, without limitation, by a screw inserted into internal threads in the abutment and in the anatomically shaped implant.

In a preferred embodiment of the present invention, where the anatomically shaped implant does not have threads or pores on its surface to encourage rapid osseointegration the anatomically shaped implant is fitted with a healing cap on its coronal end and buried under the soft tissue during the osseointegration period. After sufficient osseointegration, the implant is then recovered and attached to an implant abutment.

An implant of the present invention can be held in the socket with the aid of osseoconductive material such PepGen P-15 flow by Dentsply (York, Pa.), or with the aid of non-absorbable suture and/or guided tissue regeneration (GTR) membrane.

### SOLUTION TO PROBLEMS ABOVE

The risk of burning the bone when drilling to place an implant is avoided as an implant of the present invention can be gently tapped into the socket because of its unique custom made shape which is adapted to the socket anatomy.

The risk of impinging on or invading other anatomical structures in the oral cavity, such as the mental foramen and mental nerve, the inferior alveolar (mandibular) nerve, and the maxillary sinus, that accompanies pre-drilling to place an implant is avoided with methods and devices of the present invention because the implants of the present invention, when placed, rest inside the natural socket. In some embodiments the apical portion of the implant is 1 to 2 mm shorter than the natural socket to insure that it does not impinge upon or invade any of the above anatomical landmarks.

Even where an implant is successfully positioned by drilling and has osseointegrated, sometimes, after osseointegration, it is discovered that an implant must be removed due to its positioning at an improper angle, resulting in the inability to affix a restorative prosthesis appropriately to satisfy dental esthetic requirements. This problem is avoided with methods and devices of the present invention. With preoperative records, such as 3 dimensional images, the impression of the dental arches and the occlusion, an implant can be fabricated with a custom abutment to either mimic the natural tooth or compensate for any rotation, bucco-lingual, mesio-distal angulation needed for esthetic final restoration. Thus, even before the placement of the actual implant, the clinician and the implant manufacturer can control the final position as well as angulation of the implant in relation to the rest of the dentition and the occlusion. With this information, the fabrication of the final dental restoration or prosthesis is predictable for the patient.

Positioning a dental implant by drilling often requires additional procedures, such as sinus lifts or other bone grafting. Methods and devices of the present invention teach replacement of teeth with their natural root morphology, reducing the need for additional procedures for esthetic results.

The currently accepted implant methods that use drilling require significant skill when preparing the site for placement of the implant, including the use of multiple drill bits and complicated sequences, and the consideration of many variables. The present invention is believed to be easier to learn and practice, not requiring the challenging step of drilling into the bone.

When drilling or placing an implant after drilling, there is a risk that serious damage could occur, such as perforation of the cortical bone, breaking of the cortical bone plate breaking of the cortical bone plate, perforating the sinus, nerve damage, and damage to surrounding teeth and blood vessels, among other risks. Some patients simply make poor candidates for traditional implant techniques because the structure of the bone underlying the root does not permit drilling for any number of reasons. Devices and methods of the present invention reduce such risks because drilling is not necessary. Moreover, even if a clinician damages part of the cortical plate during extraction of a tooth prior to implant placement, this defect can be repaired right after implantation, without preventing the practice of methods of the present invention, by using available bone grafting material such as PepGen 15 putty by Dentsply (York, Pa.).

A few terms are herein defined for clarity:

“Abutment” shall mean a connecting piece that is attached to the implant for the purpose of securing a final prosthesis such as, without limitation, a single crown or bridge to the implant.

“Alveolus” shall mean an opening in the jaw-bone in which a tooth is attached.

“Anatomically shaped implant” shall mean a dental implant having a coronal and an apical portion, wherein the apical portion of the dental implant is shaped to generally conform to the contours of a specific tooth socket in a particular individual, although the surface of the apical portion may exhibit small variations from the contour of the surface of the tooth socket, for example, without limitation, threads, pores, ridges or other roughness, while still generally conforming to the contours of the tooth socket. “Anatomically shaped implant” shall encompass dental implants wherein the apical portion of the dental implant differs from the contours of the specific tooth socket for which it is intended sufficiently to prevent insertion of the dental implant into the tooth socket without altering the bony contours of the tooth socket. For example, where a root void in a tooth socket has a bend at its apical tip, which geometry would prevent the insertion of a dental implant that is formed to have a complementary bend at its tip, an anatomically shaped implant will encompass a dental implant that does not have a bent tip.

“Anatomically shaped implant section” shall mean a section of an anatomically shaped implant that is intended to fit into at least one, and less than all of the root voids of a multiple rooted tooth, whether formed by dividing a previously fabricated anatomically shaped implant into sections or formed separately from the other sections of an anatomically shaped implant in anticipation of uniting of the sections to form a complete anatomically shaped implant.

“Anterior” shall mean toward the front of the mouth.

“Apex” shall mean the very bottom of the root of a tooth or artificial implant.

“Body” of an artificial tooth shall include but shall not be limited to the part of the prosthesis representing a root structure for periodontal or osseointegration or the combined part of the prosthesis representing a root structure for periodontal or osseointegration and a support structure for a crown or a bridge.

“Buccal” shall refer to the tooth surface lying next to the cheeks.

“CAD” shall include but shall not be limited to any and all technology of computer aided design.

“CAM” shall include but shall not be limited to any and all technology of computer aided manufacturing.

“Cavity” shall include but shall not be limited to the periodontal cavity, a cavity of the jaw bone structure, a cavity of the alveolus or a combination thereof.

“CNC” shall include but shall not be limited to any and all technology of computer numerical control as it relates to manufacturing machinery and systems, including but not limited to rapid prototyping devices and systems.

“Coronal” shall mean toward the crown end of the tooth, “apical” shall mean toward the root end of the tooth, “gingival” shall mean toward the gum (gingiva.)

“Crown” shall mean the portion of an artificial tooth that is visible above the gum line.

“CT” shall include but shall not be limited to any and all technology of computed tomography.

“Dental Implant” or “implant” shall mean an artificial root structure that is placed in or adjacent to the jaw and completely or substantially below the gum line, to which may be attached an artificial tooth.

“Distal” shall mean behind or towards the back of the mouth.

“Extraction socket” shall include prepared or unprepared tooth sockets following extraction or loss of the tooth.

“Furcation” shall mean the anatomical area of a multi-rooted tooth where the roots divide.

“Healing cap” shall mean a type of abutment temporarily attached to the superior part of a dental implant to allow gingival tissues to heal prior to the placement of a permanent abutment.

“Imaging” shall include but shall not be limited to any and all technology of acquiring two-dimensional and/or three-dimensional data of physical objects or parts of a human body.

“occlusal load” of an implant shall include but shall not be limited to the situation where the occlusal portion of the implant (e.g. the crown portion facing the opponent jaw) is not protected against the load of mastication by additional protective means.

“Lingual” shall refer to the area of the tooth root or surface nearest the tongue.

“Mandibular” shall mean pertaining to the lower jaw.

“Maxillary” shall mean pertaining to the upper jaw.

“Mesial” shall mean forward or front.

“Occlusal” shall mean the chewing or grinding surface of the bicuspid and molar teeth.

“Osseointegration” shall mean the process of bone growth resulting in the direct contact of the dental implant surface with the bone of the tooth socket.

“Occlusion” shall mean but shall not be limited to the manner the teeth of the upper or lower arch are fitting and coming in contact with each other while the mouth is closed or during chewing. It shall also include the fit and contact of adjacent teeth within one arch.

“Prosthesis” shall mean an artificial replacement for one or more natural teeth.

“Periodontal ligament” shall include but shall not be limited to the fibrous connective tissue (e.g. human gingival fibroblasts) interface usually located between a human tooth and the anatomical structure of the jaw of a human being.

“Soft tissue” shall include but shall not be limited to any soft tissue surrounding a tooth and the jaw bone.

“Periodontal” shall mean pertaining to the soft tissue surrounding the tooth.

“Rapid prototyping” shall include but shall not be limited to all technologies qualified for manufacturing of copies of virtual three-dimensional objects and also technologies qualified for mass customization or the mass production of copies of customized or adapted geometries to the needs of an individual patient.

“Replacement”, “to replace”, “to be replaced” shall include but shall not be limited to any substitution, where one object fills the former position of another object. In the context of the foregoing such substitution can be performed at any time, so that for example the term replacement shall not be limited to an immediate act.

“Root” shall mean the part of the tooth or implant that is or is to be placed below the bone level.

“Root void” shall mean the void remaining within the tooth socket from one of the roots of a multi-rooted tooth or by the root of a single rooted tooth.

“Three-dimensional data” shall include but shall not be limited to surface (e.g. triangulated data) and volumetric (e.g. voxel) data.

“Tooth socket” shall mean a cavity in the alveolar process of the jaw formed by the loss or removal of a tooth.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The various embodiments and aspects of embodiments of the invention disclosed herein are to be understood not only in the order and context specifically described in this specification, but to include any order and any combination thereof. Whenever the context requires, all words used in the singular number shall be deemed to include the plural and vice versa. Words which import one gender shall be applied to any gender wherever appropriate. Whenever the context requires, all options that are listed with the word “and” shall be deemed to include the world “or” and vice versa, and any combination thereof. The titles of the sections of this specification and the sectioning of the text in separated paragraphs are for convenience of reference only and are not to be considered in construing this specification.

Insubstantial changes from the claimed subject matter as viewed by a person with ordinary skill in the art, now known or later devised, are expressly contemplated as being equivalent within the scope of the claims. Therefore, obvious substitutions now or later known to one with ordinary skill in the art are defined to be within the scope of the defined elements.

In the drawings and specification, there have been disclosed embodiments of the invention, and although specific terms are employed, the terms are used in a descriptive sense only and not for purposes of limitation, the scope of the invention being set forth in the following claims. It must be understood that the illustrated embodiment has been set forth only for the purposes of example and that it should not be taken as limiting the invention.

In the claims which follow, reference characters used to designate claim steps are provided for convenience of description only, and are not intended to imply any particular order for performing the steps.

The above specification, examples and data provide a description of the manufacture and use of the embodiments of the present invention. While the devices and related methods have been described in terms of what are presently considered to be the most practical and preferred embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims. All the patents discussed or cited above are herein incorporated by reference. Where used, the expression “without limitation” means that the options listed are not the only options contemplated by the present invention. However, even where “without limitation” is not stated, it should be appreciated that the particular implementations shown and described herein are not intended to limit the scope of the invention in any way, but are offered only as examples. Indeed, for the sake of brevity, conventional aspects of embodiments of the invention may not be described in detail herein.

1. A dental implant, comprising: a first anatomically shaped implant section and a second anatomically shaped implant section, wherein said first anatomically shaped implant section can be reversibly joined to said second anatomically shaped implant section to form an anatomically shaped implant.

2. The dental implant of claim 1, wherein said anatomically shaped implant has a coronal end, and further comprising an abutment attached to said coronal end of the anatomically shaped implant so that the first anatomically shaped implant section and the second anatomically shaped implant section are attached to the abutment.

3. The dental implant of claim 1, wherein said first anatomically shaped implant section further comprises a first apical portion and wherein said first apical portion is shaped to generally conform to the contours of a root void in a specific tooth socket in an individual.

4. The dental implant of claim 3, wherein said second anatomically shaped implant section further comprises a second apical portion and wherein said second apical portion is shaped to generally conform to the contours of a different root void of said specific tooth socket in said individual.

5. The dental implant of claim 1, further comprising: a third anatomically shaped implant section, wherein the first anatomically shaped implant section, the second anatomically shaped implant section, and the third anatomically shaped implant section can be reversibly joined to form an anatomically shaped implant.

6. The dental implant of claim 5, wherein the anatomically shaped implant has a coronal end, and further comprising an abutment attached to the coronal end of the anatomically shaped implant so that the first anatomically shaped implant section, the second anatomically shaped implant section, and the third anatomically shaped implant section are all attached to the abutment.

7. The dental implant of claim 1, wherein at least one anatomically shaped implant section further comprises: a coronal portion at a first end, an apical portion at a second end, and middle portion between the coronal portion and the apical portion, wherein a longitudinal axis passes through the first end, the middle portion and the second end, wherein the apical portion and the middle portion are custom shaped to substantially conform to a specific tooth socket of a particular individual, and wherein the middle portion has a first portion proximate the coronal portion, the first portion having a circumferentially located ridge projecting substantially perpendicular to the longitudinal axis that is designed to fit into at least one notch cut into the specific tooth socket upon insertion of the apical portion into the specific tooth socket.

8. A method of placing a dental implant section in a tooth socket, comprising:
a) providing a tooth socket a soft tissue pilot, an undercut pilot and a first anatomically shaped implant section having a first coronal portion at a first end, an apical portion at a second end, and middle portion between the first coronal portion and the apical portion, wherein a longitudinal axis passes through the first end, the middle portion and the second end, wherein the middle portion has a first portion proximate the first coronal portion, the first portion having a circumferentially located ridge projecting substantially perpendicular to the longitudinal axis,
b) removing excess soft tissue from said tooth socket by inserting said soft tissue pilot and moving it translationally within the socket,
c) inserting said undercut pilot into the tooth socket and rotating the undercut pilot more than 60 degrees until the undercut pilot rotates freely in the tooth socket, to create a notch in the tooth socket;
d) inserting said first anatomically shaped implant section into the tooth socket, and
e) applying pressure to seat said circumferentially located ridge on the first anatomically shaped implant section in the notch in the tooth socket.

9. The method of claim 8, wherein
a) said tooth socket comprises a first root void and a second root void,
b) further providing:
i) a second anatomically shaped implant section comprising a second coronal portion,
c) wherein said first anatomically shaped implant section is inserted into said first root void and said second anatomically shaped implant is inserted in said second root void.
d) The method of claim 9, further providing an abutment, wherein the first implant coronal portion and the second implant coronal portion are joined to the abutment.

10. The method of claim 8, wherein
a) said tooth socket further comprises a third root void,
b) further providing: a third anatomically shaped implant section comprising a third implant coronal portion,
c) wherein said third anatomically shaped implant is inserted in said third root void,
d) and, wherein the first implant coronal portion, the second implant coronal portion and the third implant coronal portion are joined to the abutment.

11. The method of claim 10, further providing an abutment, wherein the first implant coronal portion, the second implant coronal portion, and the third implant coronal portion are joined to the abutment.

12. A dental implant kit, comprising:
a) An anatomically shaped implant
b) a soft tissue pilot; and
c) an undercut pilot.

13. The dental implant kit of claim 12, wherein the soft tissue pilot comprises: a pilot shaft, an pilot handle at a first end of the pilot shaft, a pilot tip at a second end of the pilot shaft, wherein a long axis of the pilot shaft extends through the pilot handle, the pilot shaft and the pilot tip, and a pilot cleaning blade attached to the pilot shaft and projecting perpendicular to the long axis of the pilot shaft, wherein the pilot cleaning blade is custom shaped to fit a specific tooth socket in a particular individual.

14. The dental implant kit of claim 12, wherein the undercut pilot comprises: an undercut pilot shaft, an undercut pilot handle at a first end of the undercut pilot shaft, an undercut pilot tip stop at a second end of the undercut pilot shaft, wherein a long axis of the undercut pilot shaft extends through the undercut pilot handle, the undercut pilot shaft and the undercut pilot tip stop, a plurality of notching blades, and a plurality of guide blades, wherein the notching blades and the guide blades are affixed to the undercut pilot shaft between the undercut pilot handle and the undercut pilot tip stop and project out from the undercut pilot shaft substantially perpendicular to the long axis of the undercut pilot shaft, and wherein the notching blades and the guide blades are shaped to fit a specific tooth socket in a particular individual.

15. The dental implant kit of claim 12, wherein said anatomically shaped implant comprises a dental implant having a coronal and an apical portion, wherein the apical portion of the dental implant is shaped to generally conform to the contours of a specific tooth socket in a particular individual.
